(19) United States
(12) Patent Application Publication
(10) Pub. No.: US 2026/0266237 A1
(43) Pub. Date: Sep. 10, 2026

(54) INTERNAL COMBUSTION ENGINE

(71) Applicant: MITSUBISHI JIDOSHA KOGYO KABUSHIKI KAISHA, Tokyo (JP)

(72) Inventors: Yoshiya INOUE, Tokyo (JP); Takayuki SHIROTA, Tokyo (JP); Ryota ASAKURA, Tokyo (JP); Ryota NAKADA, Tokyo (JP); Toshiyuki YAMADA, Tokyo (JP); Kazuo KURATA, Tokyo (JP)

(73) Assignee: MITSUBISHI JIDOSHA KOGYO KABUSHIKI KAISHA, Tokyo (JP)

(21) Appl. No.: 19/162,750

(22) PCT Filed: Mar. 24, 2023
(86) PCT No.: PCT/JP2023/012055

§ 371 Date: Sep. 5, 2025

(51) Int. Cl. F02F 3/24; F02B 19/12

(52) U.S. Cl. CPC F02F 3/24; F02B 19/12

(57) ABSTRACT

An internal combustion engine includes: an ignition plug disposed in a combustion chamber; and a fuel injection nozzle configured to supply fuel to the combustion chamber. A top surface of a piston is provided with a pair of side guide portions extending along an intake and exhaust direction connecting an intake port to an exhaust port and disposed on both end sides in a crankshaft direction orthogonal to the intake and exhaust direction. A passage portion extending in a direction intersecting an extension direction is formed in each of the side guide portions.

### TECHNICAL FIELD

The present invention relates to an internal combustion engine including a fuel injection nozzle that supplies fuel to a combustion chamber.

### BACKGROUND ART

In the related art, an in-cylinder injection type internal combustion engine including a combustion chamber formed by a cylinder, a cylinder head, and a piston, an ignition plug disposed in a central portion of the cylinder head, and a fuel injection nozzle provided in the combustion chamber and supplying fuel is proposed. In the in-cylinder injection type internal combustion engine, intake air supplied into the combustion chamber via an intake port in an intake step and the fuel supplied by the fuel injection nozzle form an air-fuel mixture in the combustion chamber, and the air-fuel mixture compressed in a compression step is ignited by the ignition plug.

In the intake step and the compression step of the in-cylinder injection type internal combustion engine, the air-fuel mixture is efficiently formed by a tumble flow formed by the intake air supplied into the combustion chamber.

In order to efficiently form the tumble flow, an in-cylinder injection type internal combustion engine described in Patent Literature 1 in which a central raised portion having a cylindrical surface curved upward toward an intake direction and outer raised portions also having a cylindrical surface and positioned on both sides of the central raised portion in a cylinder row direction are provided on a piston top surface is proposed.

### CITATION LIST

### Patent Literature

Patent Literature 1: JP2000-154724A

### SUMMARY OF INVENTION

### Technical Problem

However, according to the in-cylinder injection type internal combustion engine described in Patent Literature 1, there is a problem that it is difficult for the air-fuel mixture and flame after the ignition to spread into a gap between outer sides of the outer raised portions in the cylinder row direction and the cylinder wall surface, and combustion failure is likely to occur at the outer sides of the outer raised portions.

The present invention has been made in view of the above-described problems, and an object thereof is to provide an internal combustion engine capable of achieving both formation of a stable tumble flow and combustion efficiency in a compression step.

### Solution to Problem

The above object of the present invention is achieved by following configurations.

[1] An internal combustion engine including:
a cylinder formed by a cylinder block;
a cylinder head covering one end of the cylinder;
a piston having a top surface facing the cylinder head and configured to reciprocate in the cylinder;
an ignition plug disposed in a central portion of the cylinder head in a combustion chamber formed between the cylinder, the cylinder head, and the piston;
an intake port and an exhaust port provided in the cylinder head with the ignition plug sandwiched therebetween; and
a fuel injection nozzle configured to supply fuel to the combustion chamber, in which
the top surface of the piston is provided with a pair of side guide portions extending along an intake and exhaust direction connecting the intake port to the exhaust port, protruding toward the cylinder head, and disposed on both end sides in a crankshaft direction orthogonal to a cylinder axial direction that is a reciprocating direction of the cylinder and the intake and exhaust direction, and
a passage portion extending in a direction intersecting an extension direction and making an inner surface and an outer surface of each of the side guide portions communicate with each other, is formed in each of the side guide portions.

[2] The internal combustion engine according to [1], in which
a sub-chamber accommodating the ignition plug is provided in the combustion chamber,
an injection port making the combustion chamber and the sub-chamber communicate with each other and configured to inject flame from the sub-chamber to the combustion chamber, is formed in the sub-chamber, and
the passage portion is formed on an extension line of the injection port when viewed in the cylinder axial direction.

[3] The internal combustion engine according to [1], in which
a depth of the passage portion in the cylinder axial direction increases from an outer side in an extension direction of the passage portion, which is a center side of the piston, toward an inner side in the extension direction of the passage portion, which is an edge side of the top surface.

[4] The internal combustion engine according to [1], in which
a width of the passage portion orthogonal to the extension direction and the cylinder axial direction increases from an inner side in an extension direction of the passage portion, which is a center side of the top surface, toward an outer side in the extension direction of the passage portion, which is an edge side of the top surface.

[5] The internal combustion engine according to [1], in which
the passage portion is a groove portion formed by recessing each of the side guide portions,
the top surface of the piston is formed with an inclined surface extending along the intake and exhaust direction between the pair of side guide portions and inclined toward the cylinder head as going to the intake port, and
the passage portion is provided at a position not adjacent to a top portion of the inclined surface when viewed in the cylinder axial direction.

[6] The internal combustion engine according to any one of [1] to [5], in which
the passage portion is a groove portion formed by recessing each of the side guide portions, and
a side guide width that is a width in a direction orthogonal to the extension direction of each of the side guide portions is wider on an exhaust side of the passage portion than on an intake side of the passage portion.

### Advantageous Effects of Invention

According to the internal combustion engine of the present invention, both formation of a stable tumble flow and combustion efficiency in a compression step can be achieved.

### BRIEF DESCRIPTION OF DRAWINGS

FIG. 1 is a cross-sectional view of a main part showing a schematic configuration of an internal combustion engine according to an embodiment of the present disclosure.

FIG. 2 is a plan view showing the schematic configuration of the internal combustion engine in a cylinder axial direction.

FIG. 3 is a perspective view of a piston showing a shape of a piston top surface.

FIG. 4 is a central and horizontal cross-sectional view showing the piston.

FIG. 5A is a cross-sectional view of the main part of the internal combustion engine showing a state in which the piston is raised to an intermediate point during a compression step.

FIG. 5B is a cross-sectional view of the main part of the internal combustion engine showing a state in which the piston is raised to a top dead center during the compression step.

FIG. 6 is a perspective view of a main part of the piston showing the flow of airflow guided by the piston top surface.

FIG. 7 is a plan view of the piston top surface in the cylinder axial direction, showing a flame injected from a sub-chamber.

FIG. 8 is a perspective view of the piston top surface showing groove portions provided in side guide portions.

FIG. 9A is a perspective view of a piston top surface showing other Embodiment 1 of a protruding portion.

FIG. 9B is a perspective view of a piston top surface showing other Embodiment 2 of a protruding portion.

### DESCRIPTION OF EMBODIMENTS

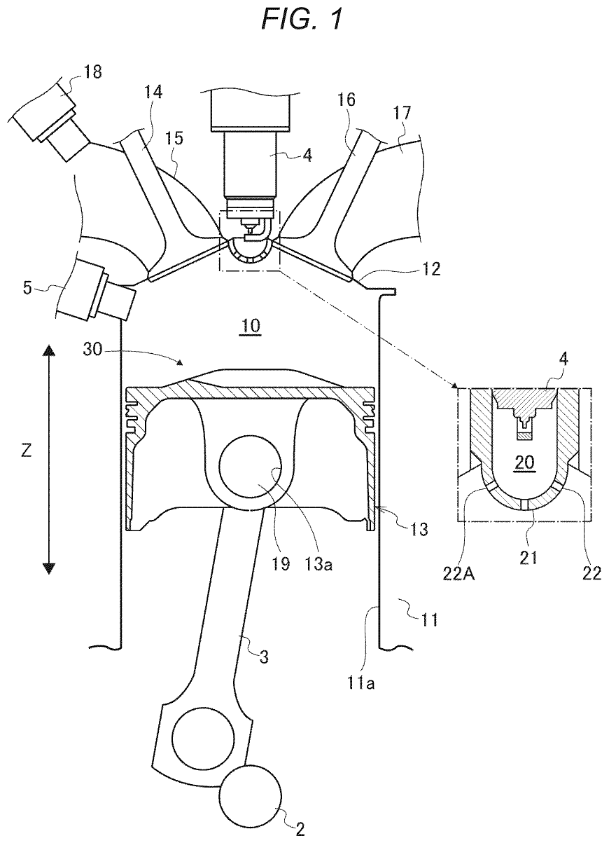

A sub-chamber type internal combustion engine (hereinafter, also simply referred to as an “internal combustion engine”) to which an in-cylinder injection type internal combustion engine according to an embodiment of the present invention is applied will be described with reference to FIGS. 1 to 8. It should be noted that the present invention is not limited to the embodiment described below, and various modifications are possible as long as the modifications have substantially the same configuration as that of the present embodiment and exhibits similar operation and effect.

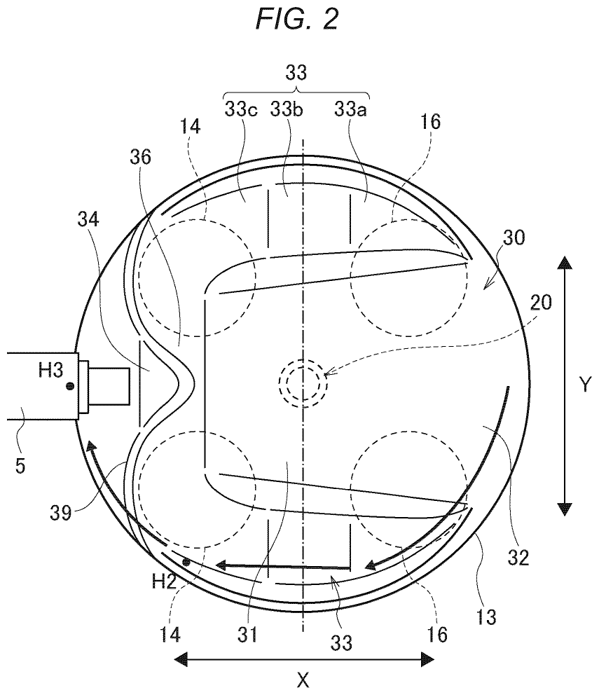

Regarding an internal combustion engine 1, in the present specification, a cylinder axial direction Z indicates a direction in which a piston slides along a cylinder. An upper-lower direction indicates the cylinder axial direction Z, and a cylinder head side is referred to as “upper” and a crankshaft side is referred to as “lower”. This configuration may be seen in FIG. 1. An intake and exhaust direction X indicates a direction connecting an intake port to an exhaust port. An “intake side” is an intake port side in the intake and exhaust direction X, and an “exhaust side” is an exhaust port side in the intake and exhaust direction X. The intake and exhaust direction X is also a direction in which fuel is injected by a fuel injection nozzle. A crankshaft direction Y is an extension direction of a crankshaft and is a direction orthogonal to the cylinder axial direction Z and the intake and exhaust direction X. The crankshaft direction Y is also a cylinder row direction disposed along the crankshaft. This configuration may be seen in FIG. 2.

### (Overall Configuration)

FIG. 1 is a cross-sectional view of a main part showing a schematic configuration of the internal combustion engine according to the embodiment of the present disclosure, and FIG. 2 is a plan view showing the schematic configuration of the internal combustion engine in the cylinder axial direction Z. The internal combustion engine 1 includes a main chamber 10 and a sub-chamber 20 forming a combustion chamber, an ignition plug 4, and a fuel injection nozzle 5.

The internal combustion engine 1 of the present embodiment is an in-line type internal combustion engine in which a plurality of cylinders each including the main chamber 10 and the sub-chamber 20 are arranged in series along a crankshaft 2. The arrangement of the cylinders may be a V type or a horizontal type.

The main chamber 10 is a space defined by a cylinder block 11 forming a cylindrical cylinder 11a extending in the upper-lower direction, a cylinder head 12 covering an upper end side of the cylinder 11a, and a piston 13 reciprocating in the cylinder 11a.

The sub-chamber 20 is a space defined by a sub-chamber wall 21 provided in the cylinder head 12. The sub-chamber 20 includes the sub-chamber wall 21 and communication passages 22 (injection ports) that make the main chamber 10 and the sub-chamber 20 communicate with each other.

The ignition plug 4 is supported at a central portion of the cylinder head 12, and a tip end side thereof is disposed in the sub-chamber 20 separated by the sub-chamber wall 21.

A pair of intake ports 15 opened and closed by intake valves 14 are connected to one side of the cylinder head 12 in the intake and exhaust direction X, and a pair of exhaust ports 17 opened and closed via an exhaust valve 16 are connected to the other side thereof. A fuel supply nozzle 18 is disposed in the intake port 15. The fuel supply nozzle 18 can supply fuel into the main chamber 10 when the intake valve 14 is opened. This configuration may be seen in FIGS. 1 and 2.

The intake port 15 is connected to an intake passage (not shown). The exhaust port 17 is connected to an exhaust passage (not shown).

The piston 13 has a piston top surface 30 configuring a lower portion of the main chamber 10 by facing the cylinder head 12, and a pin hole 13a connected to an upper end side of a connecting rod 3 via a piston pin 19, and is connected to the crankshaft 2 via the connecting rod 3. Accordingly, the piston 13 reciprocates between a bottom dead center and a top dead center in the cylinder 11a in the upper-lower direction. This configuration may be seen in FIG. 1.

The sub-chamber wall 21 has a circular cross section centered on a cylinder axis (axis passing through a center of the piston 13 and extending in the cylinder axial direction Z) in a plan view in the cylinder axial direction Z. This configuration may be seen in FIG. 2. A lower portion of the sub-chamber wall 21 is formed in a hemispherical shape when viewed in the intake and exhaust direction X and the crankshaft direction Y. This configuration may be seen in FIG. 1.

The plurality of communication passages 22 are formed along the circumferential direction of the sub-chamber wall 21 in the plan view in the cylinder axial direction Z, and make the main chamber 10 and the sub-chamber 20 communicate with each other.

The fuel injection nozzle 5 is disposed outside the sub-chamber 20 and in a peripheral edge portion of the cylinder head 12. The fuel injection nozzle 5 is disposed on an intake valve 14 side in the intake and exhaust direction X, more specifically, between the pair of intake valves 14 and 14. This configuration may be seen in FIG. 2.

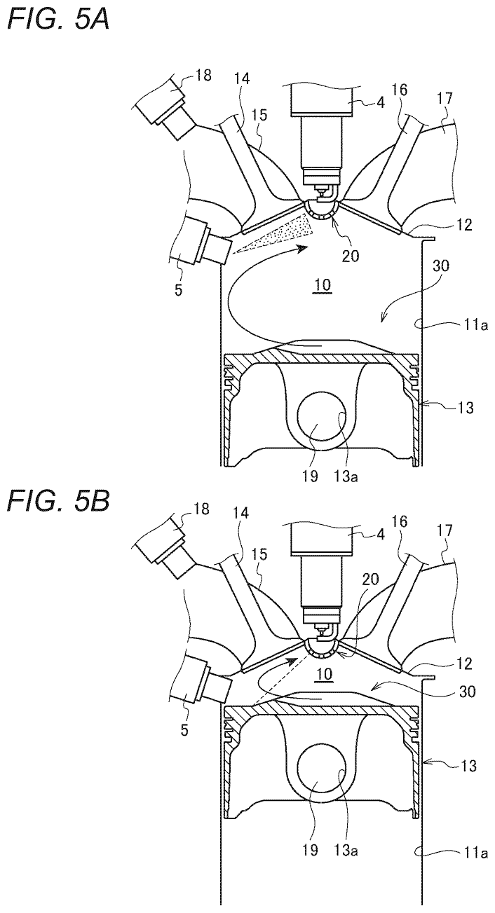

The fuel injection nozzle 5 directly injects fuel toward the ignition plug 4 in the sub-chamber 20. A first communication passage 22A, which is one of the plurality of communication passages 22, is disposed on an emission line of a fuel injection from the fuel injection nozzle 5, that is, on an extension line of a fuel injection port of the fuel injection nozzle 5. Therefore, the fuel injected from the fuel injection nozzle 5 can be directly supplied into the sub-chamber 20 via the first communication passage 22A. An extension line of the first communication passage 22A passes below the fuel injection nozzle 5. This configuration may be seen in FIG. 1 and FIG. 5A.

An amount of the fuel injected by the fuel injection nozzle 5 and a timing of the fuel injection are controlled by a controller (not shown).

The internal combustion engine 1 described above reciprocates the piston 13 inside the cylinder 11a and along the cylinder 11a by repeating an intake step, a compression step, an expansion step, and an exhaust step, and can output power from the crankshaft 2.

In the internal combustion engine 1 described above, the fuel is supplied from the fuel supply nozzle 18 in the intake port 15 into the main chamber 10 in the intake step.

At this time, intake air introduced from the intake port 15 into the main chamber 10 in the intake step is guided by the piston top surface 30, so that a tumble flow that is spiral airflow in a longitudinal direction (rotating about the crankshaft direction Y) is formed in the main chamber 10.

In the present embodiment, due to a shape of the piston top surface 30, it is possible to stably form the tumble flow that does not hinder the fuel injection to the ignition plug 4 by the fuel injection nozzle 5 when the piston 13 is rising in the compression step. A specific shape of the piston top surface 30 will be described later.

In the compression step, the fuel is injected from the fuel injection nozzle 5 toward the ignition plug 4 in the sub-chamber 20 at a predetermined timing while the piston 13 is rising, and the sub-chamber 20 is filled with the fuel. This configuration may be seen in FIG. 5A.

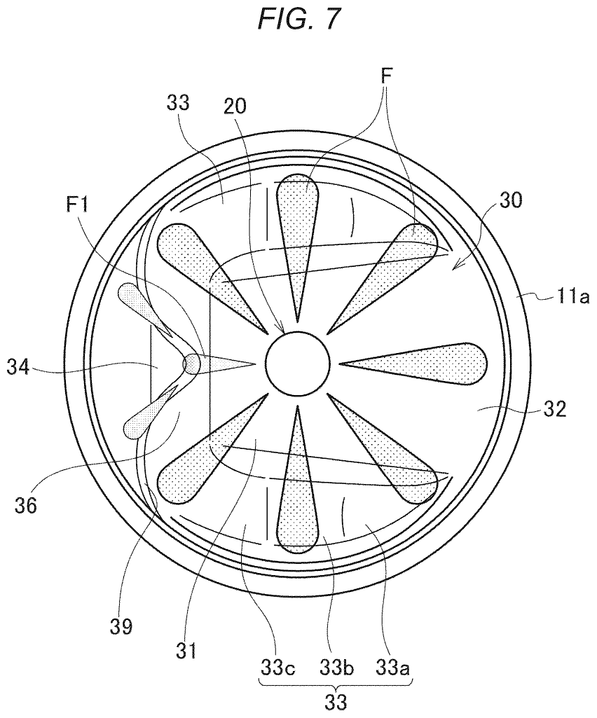

The fuel and the air-fuel mixture supplied into the sub-chamber 20 in the compression step are ignited by the ignition plug 4 and combusted in the sub-chamber 20. Accordingly, flame F generated in the sub-chamber 20 is injected from the communication passage 22 toward the main chamber 10. This configuration may be seen in FIG. 7.

The air-fuel mixture formed in the main chamber 10 is combusted by the flame F injected from the sub-chamber 20 toward the main chamber 10.

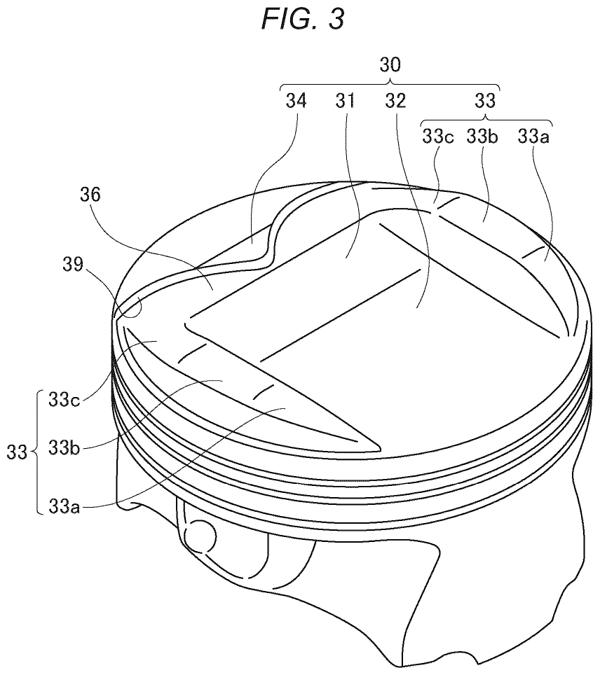

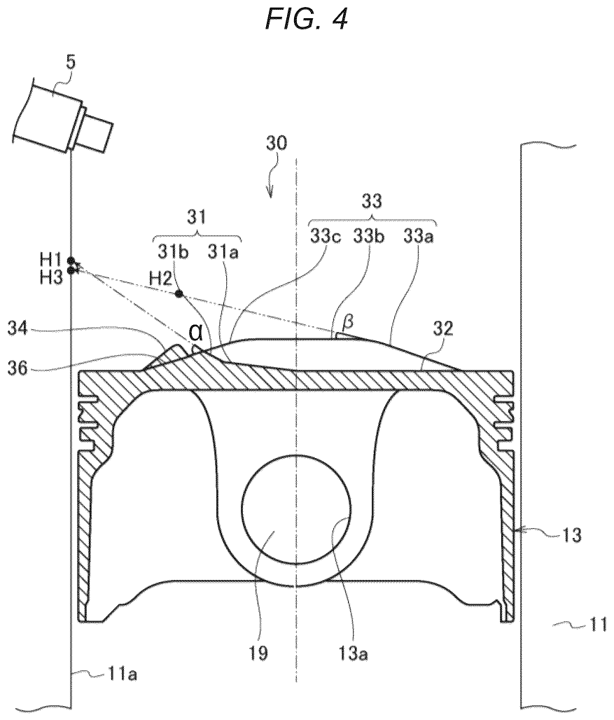

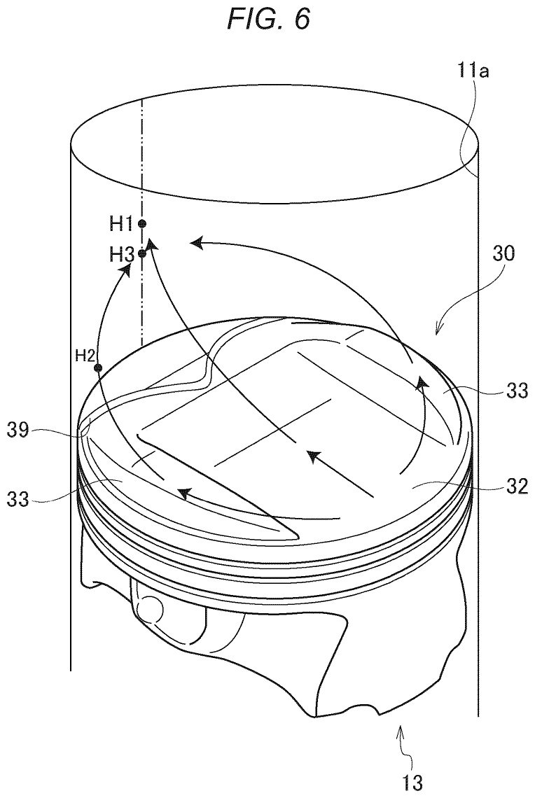

Next, a specific shape of the piston top surface will be described with reference to FIGS. 2 to 7. FIG. 3 is a perspective view of the piston showing the shape of the piston top surface, FIG. 4 is a central and horizontal cross-sectional view showing the piston, FIG. 5A is a cross-sectional view of the main part of the internal combustion engine showing a state in which the piston is raised to an intermediate point as described later during the compression step, and FIG. 5B is a cross-sectional view of the main part of the internal combustion engine showing a state in which the piston is raised to a top dead center during the compression step, FIG. 6 is a perspective view of a main part of the piston showing the flow of the airflow guided by the piston top surface, and FIG. 7 is a plan view of the piston top surface in the cylinder axial direction Z showing the flame injected from the sub-chamber.

In the plan view in the cylinder axial direction Z, the circular piston top surface 30 has an inclined surface 31 and a flat surface 32 provided on a central side in the crankshaft direction Y and extending along the intake and exhaust direction X, a pair of side guide portions 33 and 33 provided on both sides in the crankshaft direction Y with respect to the inclined surface 31 and the flat surface 32, and a protruding portion 34 and a valve recess 39 provided on the intake side with respect to the inclined surface 31.

The inclined surface 31 is formed on an intake port 15 side (intake side) in the intake and exhaust direction X, that is, on the side where the fuel injection nozzle 5 is disposed.

The inclined surface 31 is a surface extending in the intake and exhaust direction X and inclined toward a cylinder head 12 as going to the fuel injection nozzle 5. In other words, the inclined surface 31 is a surface inclined upward toward the intake side.

Specifically, in the inclined surface 31, a first inclined surface 31a and a second inclined surface 31b are continuously formed in order from the exhaust side (side opposite to the fuel injection nozzle 5) along the intake and exhaust direction X. Of the first inclined surface 31a and the second inclined surface 31b, the second inclined surface 31b disposed on the intake side has a shorter length in the intake and exhaust direction X and a steeper angle of upward inclination toward the cylinder head 12. This configuration may be seen in FIG. 4.

In an example shown in FIG. 4, the inclined surface 31 is formed of the first inclined surface 31a and the second inclined surface 31b having different angles, but the inclined surface 31 may be formed of three or more inclined surfaces having different angles as long as the inclined surface 31 has an inclination angle at which the angle of the upward inclination becomes steeper in multiple stages toward the intake side (fuel injection nozzle 5 side).

An angle at a top portion of the inclined surface 31, that is, the angle of the second inclined surface 31b in the present embodiment is set such that, when an upper-lower position of the piston 13 is within a predetermined range, the position at which an extension line of the second inclined surface 31b parallel to the intake and exhaust direction X (hereinafter, simply referred to as an extension line of the inclined surface 31) and a wall surface of the cylinder 11a intersect is on a lower side (piston side) of the fuel injection nozzle 5 in the cylinder axial direction Z. At this time, an intersection of the extension line of the inclined surface 31 and the wall surface of the cylinder 11a is defined as a first contact point H1. This configuration may be seen in FIG. 4.

Specifically, the inclined surface 31 is formed such that the extension line of the inclined surface 31 intersects the wall surface of the cylinder 11a at the first contact point H1 when the piston 13 is at least on a bottom dead center side with respect to an intermediate point between the top dead center and the bottom dead center. This configuration may be seen in FIG. 5A.

On the other hand, the inclined surface 31 is formed such that the extension line of the inclined surface 31 passes between the fuel injection nozzle 5 and the ignition plug 4 and intersects a lower surface of the cylinder head 12 when the piston 13 is at the top dead center. This configuration may be seen in FIG. 5B.

As shown in FIG. 5A, the inclined surface 31 is preferably formed such that the extension line of the inclined surface 31 intersects the wall surface of the cylinder 11a at the first contact point H1 at the timing when the fuel is injected from the fuel injection nozzle 5.

In this case, the upper-lower position of the piston 13 at the timing when the fuel is injected from the fuel injection nozzle 5 approaches the bottom dead center side as an engine rotation speed increases. Therefore, the extension line of the inclined surface 31 may be set to intersect the wall surface of the cylinder 11a at the fuel injection timing when the engine rotation speed is as high as about 5,000 rotations.

Further, when the piston 13 reaches the top dead center, the inclined surface 31 is formed such that the top portion thereof is positioned below the center line extending from an injection port 22a of the first communication passage 22A of the sub-chamber 20 when viewed in the crankshaft direction Y. This configuration may be seen in FIG. 5B. According to this configuration, it is possible to prevent the flame F injected from the sub-chamber 20 toward the main chamber 10 from directly hitting the inclined surface 31 to deteriorate the inclined surface 31.

A descending surface 36 inclined downward toward the intake side is formed on the intake side with respect to the inclined surface 31. The descending surface 36 is connected to the top portion of the inclined surface 31.

The flat surface 32 extends in the intake and exhaust direction X from an exhaust-side end portion of the piston top surface 30 toward the intake side, and is continuous with the inclined surface 31. In the present embodiment, the flat surface 32 is formed of a plane extending in parallel to the intake and exhaust direction X and the crankshaft direction Y so as to be orthogonal to the cylinder axial direction Z. This configuration may be seen in FIG. 4.

The flat surface 32 is not limited to the plane orthogonal to the cylinder axial direction Z as long as the flat surface 32 can guide the airflow toward the inclined surface by a smooth plane. For example, the flat surface 32 may be a surface gently inclined so as to have an angle with the inclined surface 31. When the flat surface 32 is inclined in the same direction as the inclined surface 31, the intake side with respect to the center of the piston 13 is defined as the inclined surface 31. By forming the exhaust side with respect to the inclined surface 31 as the flat surface 32, the airflow flowing along the piston top surface 30 can be prevented from separating from the piston top surface 30 on the exhaust side of the inclined surface 31.

The side guide portion 33 has a side guide surface 33a inclined from the exhaust-side end portion toward the cylinder head 12, a side extension surface 33b extending substantially parallel to the piston top surface 30 from an intake-side end portion of the side guide surface 33a, and a side descending surface 33c inclined downward from an intake-side end portion of the side extension surface 33b toward the piston top surface 30.

That is, when viewed in the crankshaft direction Y, the side guide portion 33 protrudes toward the cylinder head 12 in the cylinder axial direction Z, extends along the intake and exhaust direction X, and is formed in a substantially maintain shape having the intake-side end portion of the side guide surface 33a as a top portion. This configuration may be seen in FIG. 4. In the side guide portion 33, the side extension surface 33b may be inclined similarly to the side descending surface 33c. In this case, the side extension surface 33b and the side descending surface 33c are the same portion.

An angle of the side guide surface 33a is set such that, when the upper-lower position of the piston 13 is within a predetermined range, a position where an extension line of the side guide surface 33a parallel to the intake and exhaust direction X (hereinafter, simply referred to as the extension line of the side guide surface 33a) intersects the wall surface of the cylinder 11a is on the lower side (piston side) of the first contact point H1 in the cylinder axial direction Z. At this time, an intersection of the extension line of the side guide surface 33a and the wall surface of the cylinder 11a is defined as a second contact point H2.

Further, the side guide surface 33a is formed to have a gentler inclination than the inclined surface 31. This is because the top portion of the side guide surface 33a is disposed at a position closer to the wall surface of the cylinder 11a in the intake and exhaust direction X than the top portion of the inclined surface 31. By forming the side guide surface 33a to have the gentler inclination than the inclined surface 31, the second contact point H2 is lower in the cylinder axial direction Z with respect to the first contact point H1, and is on the exhaust side in the intake and exhaust direction X.

Further, as shown in FIG. 6, the side guide surface 33a is formed such that the extension line of the side guide surface 33a reaches a third contact point H3 below the first contact point H1 below the fuel injection nozzle 5 (a position overlapping with the fuel injection nozzle 5 when viewed in the cylinder axial direction Z) when the extension line extends to the intake side in the intake and exhaust direction X along an inner wall of the cylinder 11a while maintaining the angle in the upper-lower direction from the second contact point H2. This configuration may be seen in FIGS. 4 and 6.

The side descending surface 33c is inclined downward from the side extension surface 33b toward the intake side, and is smoothly connected to the descending surface 36 disposed on the intake side of the inclined surface 31. That is, the side descending surface 33c and the descending surface 36 are flush with each other. According to this configuration, of the airflow flowing in the intake and exhaust direction X along the inclined surface 31 and the flat surface 32, the airflow not separated from the inclined surface 31 and the airflow not separated from the side guide surface 33a can be prevented from getting turbulent on the intake side of the piston top surface 30. This configuration may be seen in FIGS. 2 and 6.

As described above, a first separation angle α formed between the extension line of the inclined surface 31 and the descending surface 36 is larger than a second separation angle β formed between the extension line of the side guide surface 33a and the side extension surface 33b. According to this configuration, since the airflow guided by the inclined surface 31 where the flow is the strongest is easily separated from the top portion of the inclined surface 31, the tumble flow guided by the piston top surface 30 is further stabilized. This configuration may be seen in FIG. 4. Even when the side extension surface 33b is inclined, the first separation angle α is preferably larger than the second separation angle β.

A guide width that is a width of the inclined surface 31 and the flat surface 32 in the crankshaft direction Y gradually decreases toward the intake side in the intake and exhaust direction X. Specifically, inner surfaces of the side guide portions 33 (surfaces facing the cylinder axis) are inclined in the crankshaft direction Y so as to approach each other toward the intake side. Outer surfaces of the side guide portions 33 (the surface facing the wall surface of the cylinder 11a) are formed in arc shapes along the wall surface of the cylinder 11a in the intake and exhaust direction X. The side guide portion 33 extends from the exhaust side to the intake side with respect to the cylinder axis in the intake and exhaust direction X. Therefore, a width of each of the side guide portions 33 and 33 in the crankshaft direction Y is the largest at a portion positioned at the center of the piston 13 in the intake and exhaust direction X. An inclination angle of the inner surface of the side guide portion 33 is determined such that the width of each of the side guide portions 33 and 33 in the crankshaft direction Y on the intake side with respect to the portion positioned at the center of the piston 13 in the intake and exhaust direction X is substantially constant.

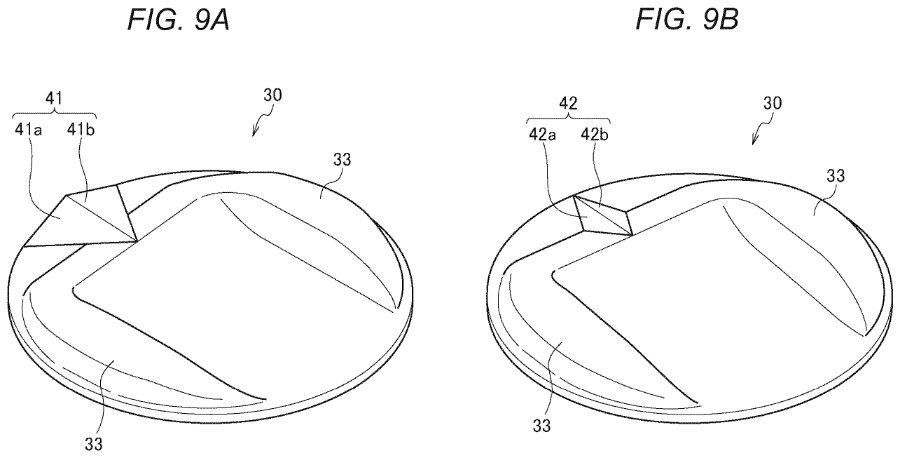

The protruding portion 34 is a protrusion formed upward on the descending surface 36. The protruding portion 34 is formed such that a width in the crankshaft direction Y decreases toward the exhaust side in the intake and exhaust direction X. A width of an intake-side end portion of the protruding portion 34 in the crankshaft direction Y is formed to be larger than a width of a tip end of the fuel injection nozzle 5 in the crankshaft direction Y. This configuration may be seen in FIG. 2. In the present embodiment, the protruding portion 34 is positioned between the pair of intake valves 14 and 14. Specifically, the protruding portion 34 is formed by using a portion having a trapezoidal shape when viewed from the cylinder axial direction Z between a pair of recesses corresponding to the intake valves 14 and 14 of the valve recess 39, which is a recess formed in accordance with the shape of the pair of intake valves 14 and 14. That is, the valve recess 39 is formed flush with the descending surface 36 and the side descending surfaces 33c, and the protruding portion 34 protrudes upward from the descending surface 36. A surface of the protruding portion 34 in the crankshaft direction Y may be inclined upward toward a central portion of the protruding portion 34 when viewed in the intake and exhaust direction X. This configuration may be seen in FIG. 9A. In this way, the airflow flowing along the descending surface 36 and the side descending surface 33c can be guided upward. Further, a shape of the protruding portion 34 may be a rhombic shape or the like, other than the trapezoidal shape when viewed in the cylinder axial direction Z as shown in FIG. 2. That is, the width of the exhaust-side end portion of the protruding portion 34 in the crankshaft direction Y may decrease toward the exhaust side. This configuration may be seen in FIG. 9B.

### Operation and Effect

Next, operation and effect of the shape of the piston top surface 30 will be described.

According to the inclined surface 31 described above, as shown in FIG. 5A, when the piston 13 is positioned on the bottom dead center side with respect to the intermediate point of the cylinder 11a during the compression step of the internal combustion engine 1, the airflow flowing on the piston top surface 30 toward the fuel injection nozzle 5 side can be guided to come into contact with the intake-side wall surface of the cylinder 11a at the first contact point H1 that is on the lower side of the fuel injection nozzle 5.

Accordingly, the fuel injected from the fuel injection nozzle 5 toward the ignition plug 4 flows toward the cylinder head 12 side due to the tumble flow generated in the main chamber 10, and it is possible to prevent the target of an injection position from shifting upward.

Further, since the guide width of the inclined surface 31 is gradually narrowed toward the fuel injection nozzle 5 side, a flow velocity of the airflow flowing on the fuel injection nozzle 5 side of the inclined surface 31 is increased, and the tumble flow is further stabilized.

Further, since the inclination angle of the inclined surface 31 gradually increases toward the fuel injection nozzle 5 side, the airflow guided by the inclined surface 31 is easily and smoothly separated at the end portion of the inclined surface 31. Therefore, the tumble flow formed by the inclined surface 31 is further stabilized.

According to the flat surface 32 described above, a downstream side of the airflow flowing along the piston top surface 30 is a plane, and the airflow flowing toward the inclined surface 31 can be prevented from separating from the piston top surface 30, so that the tumble flow is further stabilized.

According to the side guide portion 33 described above, as shown in FIG. 6, the airflow flowing toward the fuel injection nozzle 5 side along an outer edge of the piston top surface 30 can be guided to the second contact point H2 below the first contact point H1.

Accordingly, the airflow guided by the inclined surface 31 can be prevented from getting turbulent by the airflow guided by the side guide portion 33. Therefore, the tumble flow formed in the main chamber 10 by the piston top surface 30 is further stabilized.

Further, since the side guide portion 33 is formed so as to reach the third contact point H3 below the first contact point H1 when the extension line of the side guide surface 33a extends toward the fuel injection nozzle 5 along the inner wall of the cylinder 11a while maintaining the angle in the upper-lower direction from the second contact point H2, the airflow guided by the side guide portion 33 can push up the airflow guided by the inclined surface 31, and the tumble flow is further stabilized.

Further, since the side guide portion 33 is formed such that the side descending surface 33c and the descending surface 36 are flush with each other, the airflow flowing along the side descending surface 33c and the descending surface 36 can be prevented from getting turbulent without being separated from the side guide surface 33a and the inclined surface 31, and the tumble flow is further stabilized.

Further, by making the width of the side guide portion 33 from the portion having the largest width in the crankshaft direction Y to the fuel injection nozzle 5 side substantially constant, the airflow flowing along the side guide portion 33 can be prevented from getting turbulent in the crankshaft direction Y, and the tumble flow is further stabilized.

According to the protruding portion 34 described above, as shown in FIG. 7, in the plan view in the cylinder axial direction Z, flame F1 injected from the first communication passage 22A toward the fuel injection nozzle 5 of the flame F injected from the sub-chamber 20 toward the main chamber 10 can be divided in the crankshaft direction Y and diverted from the fuel injection nozzle 5. Accordingly, the influence of the flame F1 injected from the first communication passage 22A on the fuel injection nozzle 5 can be reduced.

### Other Embodiments

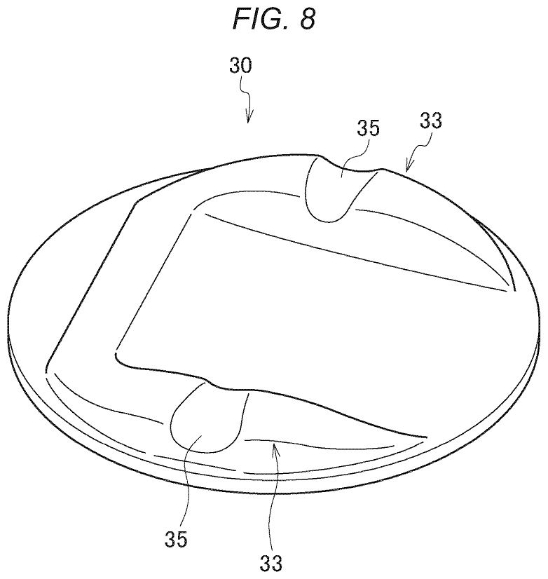

Next, a configuration of groove portions provided in the side guide portions 33 will be described with reference to FIG. 8. FIG. 8 is a perspective view of the piston top surface showing the groove portions provided in the side guide portions 33. As described above, the side guide portion 33 may be provided with a groove portion 35 as a passage portion extending in a direction intersecting an extension direction of the side guide portion 33 and making the inside and the outside of the side guide portion 33 communicate with each other.

The groove portion 35 is recessed in the cylinder axial direction Z, extends in a direction intersecting the extension direction of the side guide portion 33, that is, in the crankshaft direction Y, and is open on the inner surface and an outer surface of the side guide portion 33.

Further, a depth of the groove portion 35 in the upper-lower direction (cylinder axial direction Z) is formed to be gradually deeper from an outer side (a center side of the piston 13) toward the inner side of the groove portion 35 in the extension direction.

Further, a width of the groove portion 35, which is in the extension direction (intake and exhaust direction X) of the side guide portion 33, is formed to gradually increase from the inner side toward the outer side of the groove portion 35 in the extension direction.

According to the groove portion 35 of this configuration, by providing the pair of side guide portions 33 at an edge portion of the piston top surface 30, the flame F injected from the sub-chamber 20 can be efficiently transmitted to a gap formed between the outer side of the side guide portion 33 in the width direction (crankshaft direction Y) and the wall surface of the cylinder 11a. Therefore, the side guide portion 33 provided on the piston top surface 30 can prevent the spread of the combustion of the air-fuel mixture from being hindered outside the side guide portion 33.

Further, since the depth of the groove portion 35 in the upper-lower direction is deeper toward the inner side of the groove portion 35 in the extension direction, the flame F injected from the sub-chamber 20 is easily guided to the groove portion 35.

Further, since the width of the groove portion 35 increases from the inner side toward the outer side of the groove portion 35 in the extension direction, the flame F is easily propagated over a wider area on the outer side of the side guide portion 33 in the width direction. Therefore, the air-fuel mixture is more easily combusted outside the side guide portion 33.

Since the groove portion 35 is a groove for guiding the flame F injected from the injection port 22a of the sub-chamber 20 from the inner side to the outer side of the side guide portion 33, the groove portion 35 is not limited to the position shown in FIG. 8. Specifically, the groove portion 35 may be provided at a position where an extension line from each injection port 22a of the sub-chamber 20 and the side guide portion 33 intersect in the plan view in the cylinder axial direction Z so as to extend along the extension line from the injection port 22a, and a plurality of the groove portions 35 may be provided.

However, the groove portion 35 is not provided at a position adjacent to the top portion of the inclined surface 31 of the side guide portion 33. Accordingly, the flow of the airflow guided along the inclined surface 31 can be prevented from getting turbulent by the groove portion 35.

The side guide portion 33 may be configured such that the width in the crankshaft direction Y on the exhaust side with respect to the groove portion 35 is larger than the width in the crankshaft direction Y on the intake side with respect to the groove portion 35. Accordingly, it is possible to prevent turbulence of the airflow generated by the airflow along the side guide portion 33 passing through the groove portion 35.

The groove portion 35 is not limited to a groove formed by recessing an upper surface of the side guide portion 33, and may be a through hole drilled in the direction intersecting the extension direction of the side guide portion 33.

The present embodiment describes an example of the present invention, and the present invention is not limited to the present embodiment. In addition, various modifications or improvements can be added to the present embodiment, and embodiments to which such modifications or improvements are added can also be included in the present invention.

For example, the feature of the present invention is not limited to the internal combustion engine 1 using the sub-chamber 20 accommodating the ignition plug 4 in the main chamber 10, and similar operation and effect can be expected as long as the internal combustion engine is provided with the fuel injection nozzle 5 that injects fuel toward the ignition plug 4. In the internal combustion engine of the present disclosure, gasoline is used, but the present disclosure is not limited thereto, and other fuel such as alcohol may be used.

As described above, the following matters are disclosed in the present specification.

(1) An internal combustion engine including:
a cylinder formed by a cylinder block;
a cylinder head covering one end of the cylinder;
a piston having a top surface facing the cylinder head and configured to reciprocate in the cylinder;
an ignition plug disposed in a central portion of the cylinder head in a combustion chamber formed between the cylinder, the cylinder head, and the piston;
an intake port and an exhaust port provided in the cylinder head with the ignition plug sandwiched therebetween; and
a fuel injection nozzle configured to supply fuel to the combustion chamber, in which
the top surface of the piston is provided with a pair of side guide portions extending along an intake and exhaust direction connecting the intake port to the exhaust port, protruding toward the cylinder head, and disposed on both end sides in a crankshaft direction orthogonal to a cylinder axial direction that is a reciprocating direction of the cylinder and the intake and exhaust direction, and
a passage portion extending in a direction intersecting an extension direction and making an inner surface and an outer surface of each of the side guide portions communicate with each other, is formed in each of the side guide portions.

According to this configuration, since the side guide portion is provided with the passage portion, both the formation of the stable tumble flow and the combustion efficiency can be achieved.

(2) The internal combustion engine according to (1), in which
a sub-chamber accommodating the ignition plug is provided in the combustion chamber,
an injection port making the combustion chamber and the sub-chamber communicate with each other and configured to inject flame from the sub-chamber to the combustion chamber, is formed in the sub-chamber, and
the passage portion is formed on an extension line of the injection port when viewed in the cylinder axial direction.

According to this configuration, the flame injected from the sub-chamber can be efficiently guided to the outside of the side guide portions 33 in the crankshaft direction.

(3) The internal combustion engine according to (1) or (2), in which
a depth of the passage portion in the cylinder axial direction increases from an outer side in an extension direction of the passage portion, which is a center side of the piston, toward an inner side in the extension direction of the passage portion, which is an edge side of the top surface.

According to this configuration, the flame F injected from the sub-chamber 20 is less likely to come into contact with a side guide portion 33 side and is easily guided to the groove portion 35.

(4) The internal combustion engine according to any one of (1) to (3), in which
a width of the passage portion orthogonal to the extension direction and the cylinder axial direction increases from an inner side in an extension direction of the passage portion, which is a center side of the top surface, toward an outer side in the extension direction of the passage portion, which is an edge side of the top surface.

According to this configuration, the flame F is easily propagated over the wider area on the outer side of the side guide portion 33 in the width direction.

(5) The internal combustion engine according to any one of (1) to (4), in which
the passage portion is a groove portion formed by recessing each of the side guide portions,
the top surface of the piston is formed with an inclined surface extending along the intake and exhaust direction between the pair of side guide portions and inclined toward the cylinder head as going to the intake port, and
the passage portion is provided at a position not adjacent to a top portion of the inclined surface when viewed in the cylinder axial direction.

According to this configuration, the groove portion 35 formed in the side guide portion 33 does not interfere with the flow of the airflow guided by the inclined surface 31.

(6) The internal combustion engine according to any one of (1) to (5), in which
the passage portion is a groove portion formed by recessing each of the side guide portions, and
a side guide width that is a width in a direction orthogonal to the extension direction of each of the side guide portions is wider on an exhaust side of the passage portion than on an intake side of the passage portion.

According to this configuration, the airflow flowing along the side guide portion 33 can be prevented from getting turbulent by the groove portion 35.

### REFERENCE SIGNS LIST

1 internal combustion engine
2 crankshaft
3 connecting rod
4 ignition plug
5 fuel injection nozzle
10 main chamber
11a cylinder
11 cylinder block
12 cylinder head
13a pin hole
13 piston
14 intake valve
15 intake port
16 exhaust valve
17 exhaust port
18 fuel supply nozzle
19 piston pin
20 sub-chamber
21 sub-chamber wall
22A first communication passage (injection port)
22 communication passage (injection port)
30 piston top surface
31 a first inclined surface
31b second inclined surface
31 inclined surface
32 flat surface
33a side guide surface
33b side extension surface
33c side descending surface
33 side guide portion
34, 41 protruding portion
35 groove portion
36 descending surface
39 valve recess
H1 first contact point
H2 second contact point
H3 third contact point

1. An internal combustion engine comprising:
a cylinder formed by a cylinder block;
a cylinder head covering one end of the cylinder;
a piston having a top surface facing the cylinder head and configured to reciprocate in the cylinder;
an ignition plug disposed in a central portion of the cylinder head in a combustion chamber formed between the cylinder, the cylinder head, and the piston;
an intake port and an exhaust port provided in the cylinder head with the ignition plug sandwiched therebetween; and
a fuel injection nozzle configured to supply fuel to the combustion chamber, wherein
the top surface of the piston is provided with a pair of side guide portions extending along an intake and exhaust direction connecting the intake port to the exhaust port, protruding toward the cylinder head, and disposed on both end sides in a crankshaft direction orthogonal to a cylinder axial direction that is a reciprocating direction of the cylinder and the intake and exhaust direction,
a passage portion extending in a direction intersecting an extension direction and making an inner surface and an outer surface of each of the side guide portions communicate with each other, is formed in each of the side guide portions,
a sub-chamber accommodating the ignition plug is provided in the combustion chamber,
an injection port making the combustion chamber and the sub-chamber communicate with each other and configured to inject flame from the sub-chamber to the combustion chamber, is formed in the sub-chamber, and
the passage portion is formed on an extension line of the injection port when viewed in the cylinder axial direction.

2. (canceled)

3. The internal combustion engine according to claim 1, wherein
a depth of the passage portion in the cylinder axial direction increases from an outer side in an extension direction of the passage portion, which is a center side of the piston, toward an inner side in the extension direction of the passage portion, which is an edge side of the top surface.

4. The internal combustion engine according to claim 1, wherein
a width of the passage portion orthogonal to the extension direction and the cylinder axial direction increases from an inner side in an extension direction of the passage portion, which is a center side of the top surface, toward an outer side in the extension direction of the passage portion, which is an edge side of the top surface.

5. The internal combustion engine according to claim 1, wherein
the passage portion is a groove portion formed by recessing each of the side guide portions,
the top surface of the piston is formed with an inclined surface extending along the intake and exhaust direction between the pair of side guide portions and inclined toward the cylinder head as going to the intake port, and
the passage portion is provided at a position not adjacent to a top portion of the inclined surface when viewed in the cylinder axial direction.

6. The internal combustion engine according to claim 1, wherein
the passage portion is a groove portion formed by recessing each of the side guide portions, and
a side guide width that is a width in a direction orthogonal to the extension direction of each of the side guide portions is wider on an exhaust side of the passage portion than on an intake side of the passage portion.
